(19) United States
(12) Patent Application Publication
(10) Pub. No.: US 2006/0141009 A1
(43) Pub. Date: Jun. 29, 2006

(54) Novel compositions and processes for delivering an additive

(76) Inventors: Sebastien Huron, Salisbury, MD (US); Susan Cady, Yardley, PA (US)

Correspondence Address: INTERVET INC.;PATENT DEPARTMENT, PO BOX 318, MILLSBORO, DE, 19966-0318, US

(21) Appl. No.: 10/524,242

(22) PCT Filed: Aug. 13, 2003
(86) PCT No.: PCT/US03/25358

§ 371 Date: Nov. 29, 2005

Related U.S. Application Data
(60) Provisional application No. 60/403,201, filed on Aug. 13, 2002.
(60) Provisional application No. 60/433,677, filed on Dec. 16, 2002.

(51) Int. Cl. A23K 1/165; A23K 1/00

(52) U.S. Cl. 424/442; 426/635

(57) ABSTRACT

Embodiments of the present invention generally relate to novel compositions and processes for the delivery of an additive to an organism in a form suitable for consumption.

### RELATED APPLICATION

This application claims priority to provisional application No. 60/403,201 filed on Aug. 13, 2002, titled Novel Compositions and Processes for Delivering an Additive, and provisional application No. 60/433,677 filed on Dec. 16, 2002, titled Novel Compositions and Processes for Delivering an Additive.

### BACKGROUND OF THE INVENTION

Chewable dosage forms for drug delivery are well known to pharmaceutical technology. It is known in the pharmaceutical industry that the act of chewing increases the surface area of the available active ingredient and may increase the rate of absorption by the digestive tract. Chewable systems are also advantageous where it is desirable to make an active ingredient available topically to the mouth or throat areas for both local effects and/or systemic absorption. Further, chewable dosage forms are also utilized to ease drug administration in pediatric and geriatric patients. Examples of chewable dosage forms may be found in U.S. Pat Nos. 6,387,381; 4,284,652; 4,327,076; 4,935,243; 6,270,790; 6,060,078; 4,609,543; and, 5753,255.

Palatability and “mouth feel” are important characteristics to be considered in providing a dosage form, or matrix, for an active pharmaceutical or medicinal. Unfortunately, many pharmaceuticals and other active ingredients have a bitter or otherwise unpalatable taste, or an unacceptable mouth feel, due to the grittiness or chalkiness of the compound, or both. These characteristics make it difficult to incorporate such active ingredients into the current state of the art for chewable dosage forms because the objectionable taste and/or mouth feel make it less likely to obtain compliance by the user.

As a result, several approaches have been tried in attempting to overcome these problems. The poor taste of a pharmaceutical or other active ingredient may be masked by using suitable flavoring compounds and/or sweeteners. Encapsulation of the active ingredient may also serve to mask bitterness and other undesirable tastes. However, these approaches do not affect the physical state of the dosage form currently employed in the art. For example, chewable vitamin tablets are typically prepared as a compressed, compacted tablet, incorporating one or more active ingredients (e.g., vitamins), a sweetener and flavoring agent to mask the taste of the active ingredients, and a binder, typically microcrystalline cellulose.

Generally, chewable tablets are made by direct compression of a mixture of tableting compounds including the active ingredient, flavorant, binders, etc. The mixture is fed into a die chamber of a tablet press and a tablet is formed by direct compaction. Hardness of the resulting tablet is a direct function of the compression pressure employed. A softer tablet, having an easier bite-through, may be prepared by adding a disintegrant, such as alginic acid, to the pre-tablet mix. Alternatively, a softer tablet may be formed by employing reduced compression pressures. In either case, the resultant tablet is softer, fragile, brittle and easily chipped. Compressed, chewable tablets generally suffer from less than desirable mouth feel, i.e., chalkiness, grittiness, and a dry, powdery taste. Antacid tablets, e.g., Tums.RTM. manufactured by SmithKline Beecham Corp., Pittsburgh, Pa. and Rolaids.RTM. manufactured by Warner Lambert of Morris Plains, N.J., are each examples of typical compressed chewable tablets.

Attempts have been made to reduce the grittiness and/or chalkiness of the compressed tablet by coating particles of the active ingredient with oils or fats, which coat the particles prior to incorporation into the delivery system. In this way, the grittiness or chalkiness of the particles is masked by the oil or fat while the particles are in the mouth. In addition, tablet softness is improved. After swallowing, the oil or fat is removed and the particle can be absorbed by the digestive system. However, the addition of fats or oils to the pre-tablet mix can cause the tableting ingredients to adhere to the die chamber and cause a reduction in the binding action of the binders present in the mix. Accordingly, the art field is in search of a process of manufacturing a soft chew whereby compression and subsequent product loss may be minimized or lessened.

Other techniques for providing a chewable delivery system involve the use of a gum base. Gum bases are insoluble elastomers which form the essential element for chewing gum. The gum base is typically blended with one or more sweeteners to obtain a confectionery gum. A coating containing the active ingredient is then applied over the confectionery gum. As the dosage form is chewed, the coating fractures and/or is dissolved in the mouth and swallowed.

Other delivery systems involve the used of layered, non-homogeneous structures.

Another chewable delivery system is based on a nougat-type, chewy tablet. Such tablets generally employ a base of corn syrup (or a derivative). Such tablets are prepared as a confectionery, i.e., the corn syrup is cooked with water and a binder such as soy protein.

However, the art field has experienced problems with delivering additives/active ingredients to organisms because of palatability issues. Complex guidelines exist along the regulatory framework that make it very difficult to make and/or manufacture a palatable composition with an additive. Accordingly, the art field is in search of a method and/or composition of delivering an additive to an organism in a palatable format.

One part solution is in U.S. Pat. No. 6,387,381 (hereinafter referred to as the '381 patent). The '381 patent discloses an extrudate with formed of a matrix having starch, sugar, fat, polyhydric alcohol and water in suitable ratios such that there exists a water activity of 0.6-0.75, for carrying an active ingredient. The water activity of the product matrix may be adjusted up or down for the active ingredient, be it pharmaceutical, nutraceutical, or a vitamin mineral complex. The claimed product is directed towards a product containing an additive, an extrudate comprising a matrix having about 10 to about 50% wt starch, a sweetener consisting essentially of sucrose, corn syrup and sorbitol, said sucrose being in an amount of at least 10%, and at least about 5% wt water, said composition having A_{w} of about 0.60 to about 0.75, and a soft and chewy texture, and said A_{w} being adjusted to permit an appropriate amount of free water in the presence of the additive. However, this product is limited to an extrudate and not available in a tablet form of formulation.

### SUMMARY OF THE INVENTION

Embodiments of the present invention provide novel compositions and processes for the delivery of an additive. In various embodiments, the additive is selected from the group consisting of a pharmaceutical, a nutraceutical, a vitamin, a mineral, and a filler. In a preferred embodiment, a soft chew of the present invention comprises a sugar component, a starch component, an oil component, and an additive component. In a more preferred embodiment, the composition further comprises a flavoring component. In a most preferred embodiment, the flavoring is chosen to improve the palatability of the soft chew.

Further, embodiments of the present invention comprise processes for forming a soft chew of the present invention. In an embodiment, a process of the present invention comprises forming the soft chew in a forming machine, such that the formed soft chew and/or punched out soft chew, not an extrudate.

In an embodiment, ingredients of a soft chew of the present invention are uniformly dispersed throughout the soft chew. In another embodiment of a soft chew of the present invention, ingredients are at least partially separated, such as when an embodiment has distinct layers, segments, and/or zones.

Further embodiments of the present invention comprise processes for treating and/or delivering an additive to an organism, such process(es) being adaptable to the size of the organism for treatment and/or delivery of an appropriate amount of additive to the organism.

### BRIEF DESCRIPTION OF THE DRAWINGS

FIG. 1a is an illustration of an embodiment of a composition of the present invention.

FIG. 1b is an illustration of an alternate embodiment of a composition of the present invention.

FIG. 2 is an illustration of an embodiment of a forming apparatus used in forming embodiments of compositions of the present invention.

FIG. 3 is an illustration of an embodiment of knock out used to form an embodiment of the present invention.

### DETAILED DESCRIPTION OF THE INVENTION

As used herein, the term “cookie” and “soft chew” and any conjugation thereof, means and refers to an edible composition.

As used herein, the term “sugar,” and any conjugation thereof, means and refers to any saccharide which is at least partially soluble in moisture, non-toxic, and preferably not provide any undesirable taste effects. Further, the use of the term “sugar” shall include a “sugar substitute.”

As used herein, the term “sugar substitute,” and any conjugation thereof, means and refers to any compound that produces a like effect as sugar, but does not require the same or magnitude of effect that a comparable amount of a sugar would produce.

As used herein, the term “Parasite,” and any conjugation thereof, means and refers to a specie and/or species of organism treated by a pharmaceutical, non-limiting examples of which are included herein. Internal and external parasites of Equidae, Canidae, Felidae, Bovidae, Ovidae, Capridae, Suidae which include but are not limited to the pseudophyllidean and cyclophyllidean tapeworms, digenean flukes nematodes in the orders Rhabditida, Strongylida, Oxyurida, Ascaridida, Spirurida and Enoplida insects in the orders Siphonapter, Diptera, Mallophaga, Anpolura, and the suborders of arachnida including parasitic mites and ticks mesostigmata, astigmata, prostigmata and metastigmata. Exemplary, non-limiting parasites of horses (parasites of other species are also contemplated) include, but are not limited to, large strongyles, such as, but not limited to Strongylus vulgaris, S. edentatus, and S. equines; small strongyles including, but not limited to, those resistant to some benzimidazole class compounds, Triodontophorus spp., Cyathostomum spp., Cylicocyclusspp., Cylicostephanusspp., and Cylicodontophorus spp.; pinworms, such as, but not limited to Oxyuris equi; Ascarids, such as, but not limited to, Parascaris equorum; Hairworms, such as, but not limited to, Trichostrongylus axei; largemouth stomach worms, such as, but not limited to Habronema muscae; neck threadworms, such as, but not limited to Onchocerca spp.; bots, such as, but not limited to, Gastrophilus spp.; lungworms, such as, but not limited to, Dictyocaulus arnfieldi; intestinal threadworms, such as, but not limited to, Strongyloides westeri; summer sores caused by Habronema and Draschia spp., and other cutaneous larvae; and other parasites that are common in the art. However, parasites of other species are specifically contemplated as falling within the scope of the invention.

As used herein, the term “amylaceous ingredients” is meant those food-stuffs containing a preponderance of starch and/or starch-like material. Examples of amylaceous ingredients are cereal grains and meals or flours obtained upon grinding cereal grains such as corn, oats, wheat, milo, barley, rice, and the various milling by-products of these cereal grains such as wheat feed flour, wheat middlings, mixed feed, wheat shorts, wheat red dog, oat groats, hominy feed, and other such material. Also included as sources of amylaceous ingredients are the tuberous food stuffs such as potatoes, tapioca, and the like.

As used herein, percents of components of the soft chew means and refers to percentages of the total weight of the soft chew.

As used herein, the term “starch component” shall mean and refer to a starch or starches component and is considered a dry component, whether or not actually dry. As used herein, the term “sugar component” shall mean and refer to a sugar or sugars and/or sugar substitute component and is considered a dry component, whether or not actually dry. As used herein, the term “oil component” shall mean and refer to an oil or oils component and is considered a liquid component, whether or not actually liquid. As used herein, the term “additive component” shall mean and refer to an additive or additives. As used herein, the term “emulsifier component” means and refers to an emulsifier or emulsifiers, humectants and the like and is considered a liquid component, whether or not actually liquid.

Embodiments of a composition of the present invention are an edible delivery vehicle or soft chew for the delivery of an additive to an organism. Such organism may be any organism. Especially considered organisms include livestock, pets, farm animals, and the like, including, but not limited to, horses, cows, pigs, goats, sheep, llamas, deer, ducks, chickens, dogs, cats, lions, tigers, bears, oxen, buffalo, fish, birds, insects, and the like.

In various embodiments, the additive is selected from the group consisting of a pharmaceutical, a nutraceutical, a vitamin, a mineral and a filler. Embodiments of the soft chew of the present invention deliver reasonable levels of the additive, thereby producing the desired effect for the additive. The soft chew, in various embodiments, may be pleasant tasting and/or palatable to an organism.

In an embodiment, a composition of the present invention comprises a starch component, a sugar component, and an oil component. Generally, in various embodiments, the starch component comprises about 5 percent to about 60 percent of the soft chew, the sugar component comprises about 5 percent to about 75 percent of the soft chew, and the oil component comprises about 1 percent to about 40 percent of the soft chew. The percentages of the starch component, sugar component, and/or oil component may be varied depending upon the end use and desired consistency of the soft chew.

In an alternate embodiment, the starch component comprises about 15 percent to about 40 percent of the soft chew, the sugar component comprises about 15 percent to about 60 percent of the soft chew, and the oil component comprises about 5 percent to about 30 percent of the soft chew.

In an alternate embodiment, the starch component comprises about 25 percent to about 35 percent of the soft chew, the sugar component comprises about 25 percent to about 50 percent of the soft chew, and the oil component comprises about 7 percent to about 15 percent of the soft chew.

The starch component may comprise starch from any source and may act as a binder in the soft chew. In an embodiment, the starch component is derivatized and/or pregelatinized. In a preferred embodiment, the starch component is highly derivatized. Some starches that can serve as a base starch for derivatization include regular corn, waxy corn, potato, tapioca, rice, etc. Suitable types of derivatizing agents for the starch include, but are not limited to, ethylene oxide, propylene oxide, acetic anhydride, and succinic anhydride, and other food approved esters or ethers, introducing such chemicals alone or in combination with one another.

In various embodiments, prior cross-linking of the starch in the starch component may or may not be necessary, based on the pH of the system and the temperature used to form the product.

The starch component may also include amylaceous ingredients. The amylaceous ingredients can be gelatinized or cooked before or during the forming step to achieve the desired matrix characteristics. If gelatinized starch is used, it may be possible to prepare the product of the subject invention or perform the process of the subject invention without heating or cooking. However, ungelatinized (ungelled) or uncooked starch may also be used.

The sugar component may act as a sweetener and may comprise sugars including, but not limited to, white sugar, corn syrup, sorbitol (solution), maltitol (syrup), oligosaccharide, isomaltooligosaccharide, fructose, lactose, glucose, lycasin, xylitol, lactitol, erythritol, mannitol, isomaltose, polydextrose, raffinose, dextrin, galactose, sucrose, invert sugar, honey, molasses, polyhydric alcohols and other similar saccharides oligomers and polymers and mixture thereof. In addition, artificial sweeteners such as saccharine, aspartame and other dipeptide sweeteners may be present and sugarless can include solid polyols such as Sorbitol, Mannitol and Xylitol. Examples of various well established sources of a portion of these sugars are, corn syrup solids, malt syrup, hydrolyzed corn starch, hydrol (syrup from glucose manufacturing operations), raw and refined cane and beet sugars, and the like.

The oil component may act as a humectant and may comprise more than one oil including, but not limited to, fat or fats, both natural and synthetic. Oil employed as an ingredient in the soft chew may be a saturated or unsaturated liquid fatty acid, its glyceride derivatives or fatty acid derivatives of plant or animal origin or a mixture thereof. A source for typical animal fats or oils are fish oil, chicken fat, tallow, choice white grease, prime steam lard and mixtures thereof. However, other animal fats are also suitable for use in the soft chew. Suitable sources for vegetable fats or oils can be derived palm oil, palm hydrogenated oil, corn germ hydrogenated oil, castor hydrogenated oil, cotton-seed oil, soybean oil, olive oil, peanut oil, palm olein oil, Cacao fat, margarine, butter, shortening and palm stearin oil, and mixtures thereof. Additionally, a mixture of animal or vegetable oils or fats is suitable for use in the matrix.

Various other embodiments further comprise a flavoring component. Such flavoring component, in an embodiment, is to improve and/or change the palatability of the soft chew. Any flavoring in the flavoring component may be used. Examples of suitable flavor for the flavoring component includes, but is not limited to, strawberry flavor, tutti fruity flavor, orange flavor, banana flavor, mint flavor, and an apple-molasses. A suitable source for an apple-molasses flavoring component is Pharma Chemie, 1877 Midland Street, P.O. Box 326, Syracuse, Neb. 68446-0326, under a product name of Sweet-Apple Molasses Flavoring, Product Code PC-0555.

In various embodiments, other flavorings for the flavoring component may be used, such as fruit, meat (including, but not limited to pork, beef, chicken, fish, poultry, and the like), vegetable, cheese, cheese-bacon and/or artificial flavorings. In preferred embodiments utilizing a flavoring component, the flavoring component is chosen to enhance the palatability of the composition. A preferred meat flavoring is commercially available at Pharma Chemie as Artificial beef flavor product code PC-0125. A flavoring component is typically chosen based upon consideration related to the organism that will be ingesting the soft chew. For example, a horse may prefer an apple flavoring component, while a dog may prefer a meat flavoring component.

Various embodiments further comprise a stabilizer and/or lubricating component. In an embodiment, suitable stabilizer components are Magnesium Stearate, citric acid, sodium citrate, and/or the like. However, stabilizer components are common in the art and any suitable one or mixture of more than one may be used. In an embodiment, a stabilizer component comprises about 0.0 percent to about 3.0 percent of the soft chew. In an alternate embodiment, a stabilizer component comprises about 0.5 percent to about 1.5 percent of the soft chew.

Various embodiments further comprise an emulsifier component. A suitable emulsifier component is a glycerin, glycerin fatty acid ester, sorbitan monostearate, sucrose fatty acid ester, lecithin, polyethylene glycol, mixtures thereof, and the like. However, emulsifier components are well-known in the art field and any emulsifier component may be used. Generally, the amount of emulsifier component added may affect the stickiness of the soft chew. The greater the concentration of glycerin, the stickier the soft chew. In an embodiment, an emulsifier component comprises about 0.0 percent to about 40 percent of the soft chew. In an alternate embodiment, an emulsifier component comprises about 5.0 percent to about 30 percent of the soft chew. In an alternate embodiment, an emulsifier component comprises about 10 percent to about 20 percent of the soft chew.

In various embodiments, a moisture component is in the composition. In an embodiment, a moisture component comprises about 0.0 percent to about 15 percent. In an alternate embodiment, a moisture component comprises about 2.0 percent to about 10 percent. In an alternate embodiment, a moisture component comprises about 5.0 percent to about 7.5 percent.

In various embodiments, an additive component is added to the composition. The additve component is selected from the group consisting of a pharmaceutical, a nutraceutical, a vitamin, a mineral and/or a filler that can be orally administered. In this regard, an additive component may be an active ingredient or an inactive ingredient.

Exemplary pharmaceuticals include, but are not limited to, ivermectin, fenbendazole, piperazine, magnesium hydroxide, stranozole, furosemide, penicillin, amoxicillin, prednisolone, methylprednisolone, acepromazine, aspirin, PROZAC, ZANTACS, BENADRYL, praziquantel, pyrantel, HOE 12073, Sumitomo Chemicals-1638, Nitenpyram, spinosad and omyprazole.

Various embodiments of the present invention contemplate a soft chew with more than one pharmaceutical/additive. Exemplary embodiments with more than one pharmaceutical include, without limitation, ivermectin with Omeprazole, with Fenbendazole, with Pyrantel pamoate to be used in rotation with fenbendazole, with fenbendazole and praziquantel, with ivermectin and pyrantel pamoate, with Selamectin, with Praziquantel and pyrantel pamoate for cats, milbemycin and praziquantel for dogs and cats to control nematodes and tapeworms, furosemide in dogs, cats, horses, cattle. Further embodiments substitutes praziquantel for epsiprantel, fenbendazole for benzimidazole, ivermectin for macrolide anthelmintic, and the like. Generally, any drug that is given as a tablet could be put in this soft chew, as long as the excipients in the formulation wouldn't cause a stability problem or combine with them is such a way as to make them inactive. Specifically contemplated soft chews of the present invention may be identified as single additive, dual additive, three-way, four-way, and so on. In such embodiments, the soft chews comprise a first additive and/or a second additive and/or a third additive and/or a fourth additive and/or so on. Accordingly, an additive component of the present invention may comprise more than one additive. Preferably, additives are chosen that will not interfere with one another, so as not to make a non-operative soft chew.

In various embodiments, the additive is coated. Any suitable coating may be used. In an embodiment, a coating is chosen that will not interfere with an additive. In another embodiment, an additive is chosen that can modify the time for digestion of the additive(s), thereby at least partially controlling the release of the additive(s). Suitable coatings include, but are not limited to, and may be any pharmaceutically acceptable, and/or neutraceutically acceptable coating, as is common in the art.

Exemplary nutraceuticals, vitamins, minerals, and the like include, but are not limited to, vitamins such as vitamin A, vitamin B.sub.1, vitamin B.sub.2, vitamin B.sub.6, vitamin B.sub.12, vitamin C, vitamin D, vitamin E, vitamin K, nicotinamide, folic acid, calcium pantothenate, biotin and mixtures thereof; mineral supplements such as calcium, calcium carbonate, calcium phosphate, magnesium, magnesium carbonate, magnesium glycerophosphate, manganese, potassium, lecithin, iron, copper, zinc, phosphorus, hippophae rhamnoides ext., pollen, Garcinia, Echinaceae, ginsenoside ext., Ginkgo biloba ext., blueberry, hawthorn ext., acanthopanax ext., aloe ext., Cardus marianus ext., chromium picolinate, potassium gluconate and methionine amino acid, iron, copper, zinc, and mixtures thereof.

Exemplary fillers include, but are not limited to, a carbohydrate source, a protein source, antioxidants, such as Tenox 8, gum, colorants, dyes, pigments, and the like. Generally, any ingredient may be used as a filler. In preferred embodiments, the filler is chosen so as not to adversely affect the palatability of the soft chew.

An embodiment of a process for forming a soft chew of the present invention comprises the steps of:

mixing a starch component, a sugar component, an oil component, and an additive component;

optionally heating at least a portion of the components; and, forming embodiments of the soft chew.

If an additive is present in the embodiment of the soft chew, the additive component may be mixed along with the other components or at a later step and/or time in the process. In an alternate embodiment, the components are mixed completely to produce a mixed dough. In a most preferred embodiment, the dough is mixed until there is a uniform dispersal of the components in the dough.

In a further embodiment, the process further comprises mixing an emulsifier component. The emulsifier component may be chosen to act as a humectant and/or a forming agent. In an embodiment, a forming agent of choice is polyethylene glycol (PEG). Moreover, depending upon the desired consistency of the soft chew, different molecular weight PEG may be. utilized. In an embodiment, PEG 3350 is utilized. However, the PEG chosen is a matter of choice and the molecular weight may be higher or lower than 3350.

Embodiments of processes of the present invention may further comprise mixing a stabilizer component, a flavoring component, and/or a filler component.

In an embodiment, the dry components are mixed and the liquid components are mixed separately. In an embodiment, the oil component and the emulsifier component are heated when mixing and added, at sufficient temperature, to the dry components. The liquid and dry components are then mixed together until a desired dough is obtained. However, the process by which the components are mixed and/or heated into a dough may be varied. Moreover, the degree of mixing may be varied, such that, in various embodiments, the dough is not uniformly mixed and remains striated. Likewise, various embodiments of dough of the present invention have discrete zones and/or layers.

In an embodiment, an additive(s) component is added during mixing of the components. In an alternate embodiment, an additive component is injected into the soft chew after forming. In an alternate embodiment, a dough is formed about an additive component. In another embodiment, an additive(s) is mixed and/or dissolved in an alcohol or other liquid prior to adding with a dough and/or components of the present invention. In alternate embodiments, an additive(s) component is sprayed into a dough while mixing. The particular process for mixing the additive in the dough may be dependant upon considerations, including the stability of the additive, the temperature sensitivity of the additive, and/or the like. In a preferred embodiment, the additive is uniformly mixed and/or dispersed in the dough.

In another embodiment, the oil component is heated prior to mixing the components, whereby The dough is then formed into a soft chew of the present invention by a knockout. In an embodiment, the dough is formed while still warm. The dough may be formed into a soft chew by any means or method common in the art, such as by hand or by machine. In an embodiment, a forming machine or patty machine is utilized, such that the soft chew is formed out of the dough. Suitable examples of forming machines are exemplified in U.S. Pat. Nos. 5,165,218, 7,780,931, 4,523,520, and 3,887,964. A most preferred forming machine is the FORMAX machine manufactured by FORMAX Food Machines, Mokena, Ill.

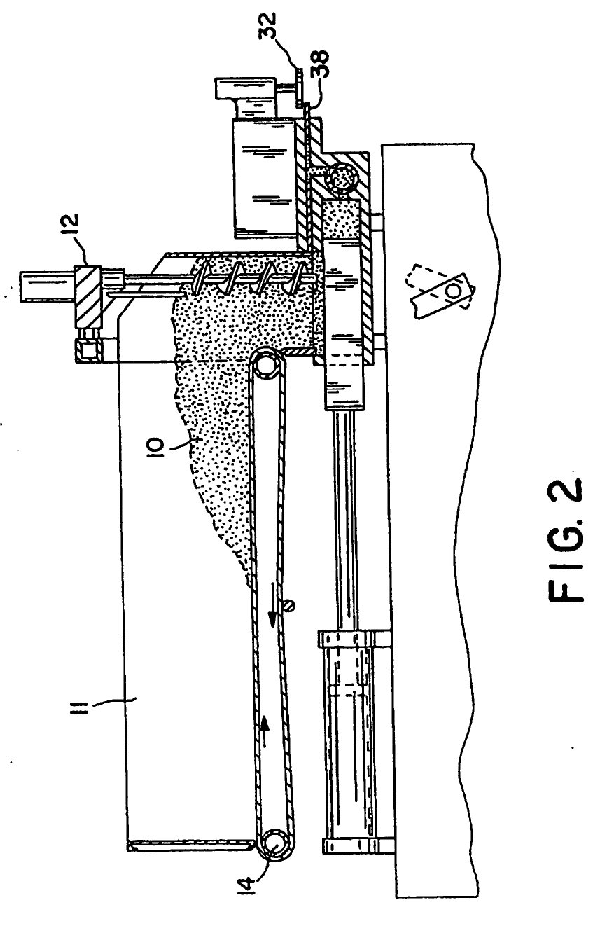

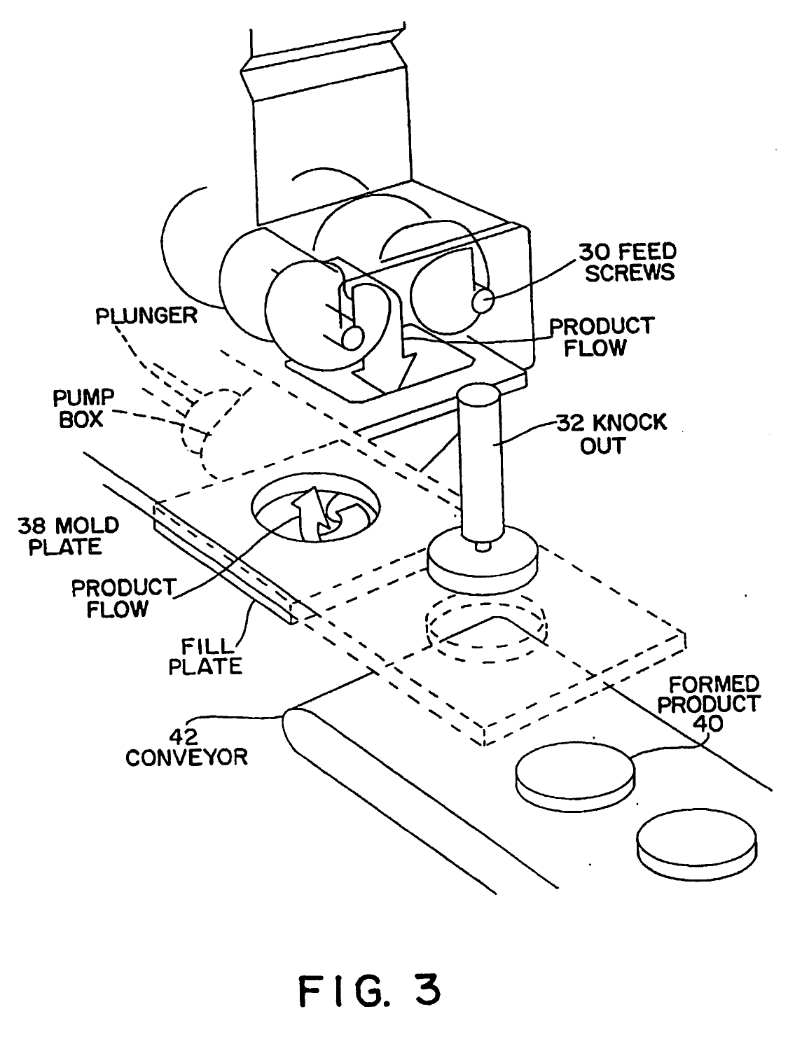

Now referring to FIG. 2, an illustration of an embodiment of a forming apparatus used in forming embodiments of compositions of the present invention, a general preferred embodiment for forming soft chews of the present invention will be discussed. Generally, dough 10 is added to hopper 11. Screw(s) 12 and conveyor 14 move dough 10 through feed screw(s) 30 and onto mold plate 38. Knock out 32 then forms a soft chew of the present invention. Reference to FIG. 3, an illustration of an embodiment of knock out used to form an embodiment of the present invention, illustrates a preferred embodiment of soft chew 40. However, any size or shape knock out is acceptable. Soft chew 40 is then conveyed along conveyor 42. Soft chew 40 may be used, packaged, or as is desired.

In an embodiment, dough 10 is formed into soft chew 40 while still warm. However, dough 10 may be formed into soft chew 40 at any desired temperature.

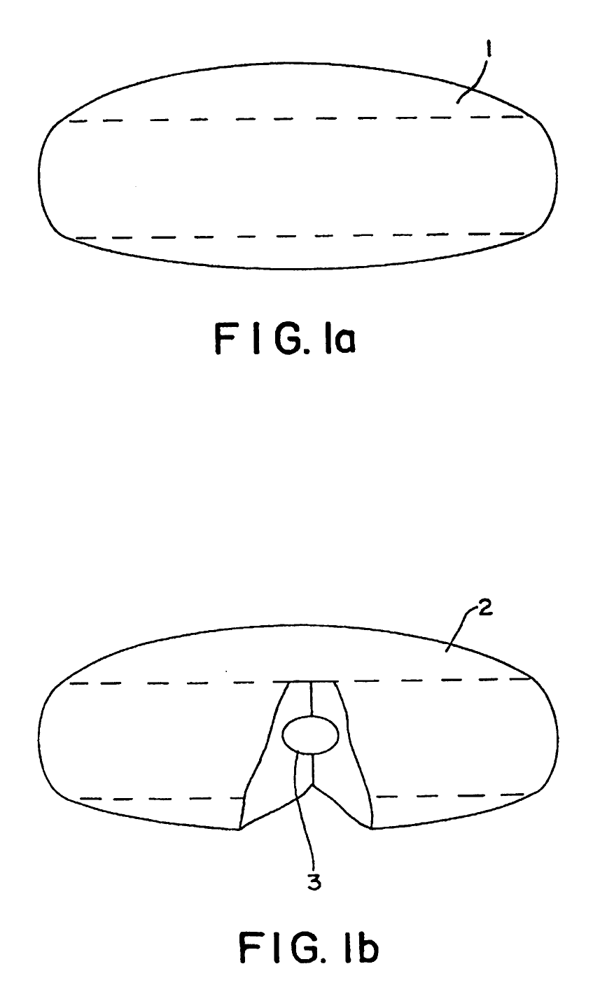

Embodiments of a soft chew of the present invention may have different textures, crispyness, hardness, and the like. In an embodiment texture of the soft chew will be smooth. In other embodiments, the texture of the soft chew will be rough. Now referring to FIG. 1a, an embodiment of a soft chew of the present invention, a soft chew 1 that was formed from a uniformly mixed dough is illustrated. However, FIG. 1b illustrates a soft chew 2 with more than one zone. Whether the dough is uniformly mixed or not may be dependent upon various factors, including the type of additive, consistency of soft chew, and/or the like.

Further embodiments of the present invention are for a process of introducing an additive to an organism. Suitable examples of organisms are livestock, pets, farm animals, and the like, including, but not limited to, horses, cows, pigs, goats, sheep, llamas, deer, ducks, chickens, dogs, cats, lions, tigers, bears, oxen, buffalo, fish, birds, insects, and the like. In an embodiment, the organism is a horse and the additive is ivermectin and/or other pharmaceutical and the process of treating a horse for worms comprises the steps of: obtaining an embodiment of a soft chew of the present invention and offering the soft chew to the horse whereby, upon consumption, ivermectin and/or other pharmaceutical(s) is released.

Dosage requirements for embodiments of the present invention will vary and should be chosen to be within established veterinary parameters. In various embodiments, dosage delivered to an organism may be adjusted by offering more or less units of soft chews to the organism, one soft chew supplies enough additive for a certain weight organism.

While the invention has been described in connection with specific embodiments thereof, it will be understood that it is capable of further modifications and the appended Claims are intended to cover any variations, uses, or adaptations of the invention following, in general, the principles of the invention and including such departures from the present disclosure as come within known or customary practice within the art to which the invention pertains and as may be applied to the essential features hereinbefore set forth whether now existing or after arising. Further, while embodiments of the invention have been described with specific dimensional characteristics and/or measurements, it will be understood that the embodiments are capable of different dimensional characteristics and/or measurements without departing from the principles of the invention and the appended Claims are intended to cover such differences. Furthermore, all patents mentioned herein are herby incorporated by reference.

For a further understanding of an embodiment of the present invention, reference should be had to the following examples:

### EXAMPLES

The following placebo experiments were conducted to test the palatability of embodiments of a soft chew of the present invention:

### Example 1a

Equine Soft Chew

Mixture of Components:

A batch of placebo dough was made with the following components: Each component is illustrated in grams/batch. There was no additive added.

| Ingredients | gram/batch |
|---|---|
| Sweet Apple & Molasses Flavor (PC-0555) | 2699.3 |
| Corn Starch, NF | 2800.0 |
| Sucrose, NF | 1500.0 |
| Magnesium Stearate, NF | 100.0 |
| Soybean Oil, USP | 700.0 |
| Glycerin, USP | 1300.0 |
| Tenox 8 | 0.7 |
| Polyethylene Glycol, NF 3350 | 900.0 |
| Total Lot Weight: | 10000.0 g |

The process used for mixing the components was as follows:

1. All the components were weighed.

2. All the dry components, beginning with the Sweet Apple & Molasses Flavor, then the corn starch, then the sucrose, and then the magnesium stearate were mixed in a 20 quart Hobart mixer at speed 1 for about 1 minute, to produce a uniform blend.

3. The liquid components, beginning with the soybean oil, then the glycerin, and then the tenox 8 were mixed in a steel beaker with a spatula.

4. The polyethylene glycol was then heated to 60° C. in a stainless steel beaker to form a liquid.

5. The liquid from step 3 was then added to the Hobart mixer and mixed for 5 minutes to produce a wet granulation mix.

6. The melted PEG from step 4 was then added to the Hobart mixer and mixed for 15 minutes to produce a wet granulation mix.

7. The wet granulation mix was then added to a Formax F6 machine to produce soft chews of the present invention.

Physical Characteristics of the Soft Chew:

The soft chews formed from the above section had the following general characteristics:

| | | |
|---|---|---|
| Soft chew Weight: | 4850.0 | mg |
| Soft chew Hardness | 0.0 | Kp |
| Soft chew Thickness | 0.521 | inches |
| Soft chew Friability | 0.00% | |
| Time to Disintegrate | 14.45 | minutes |
| (6 soft chews, 37° C.) | | |

Control Soft Chew:

A control soft chew was chosen for comparison of the palatability of the placebo embodiment of the present invention. A product identified as MRS. PASTURES' SOFT CHEWS FOR HORSES was chosen as a control. The control contained oats, wheat, bran, cane molasses, rolled barley, apples and water. The control soft chew weighed 10 grams.

Palatability Study:

A palatability study was conducted as follows:

1. Twenty horses were evaluated over a two day period with the placebo as compared to the control with two offerings in a day.

2. Two product offerings were made to each horse on each day. One offering was four of the placebo soft chews and the other offering was one of the control soft chews. Each product offering was divided into two parts. The first part was a free choice evaluation where each test horse was offered, for consumption, either the control or an embodiment of the present invention. If the test horse refused the soft chew on free choice, the soft chew was placed in the test horse's feed to see if the horse would consume the soft chew.

3. The study was repeated on a subsequent day in a varied order of offerings to remove experimental bias.

100.0% of the test horses consumed the control upon free choice. 97.5% of the test horses consumed the soft chew of the present invention upon free choice. 2.5% of the test horses consumed the soft chew of the present invention upon placing the soft chew in the horse's feed. Therefore, all of the test horses consumed the soft chew. The results of the study illustrate that an embodiment of a soft chew of the present invention is palatable for a horse.

### Example 1b

Equine Soft Chew with Ivermectin

Mixture of Components:

A batch of dough with active/additive ingredient was made with the following components: Each component is illustrated in grams/batch.

| Ingredients | gram/batch |
|---|---|
| Ivermectin (97.6% purity)(5% overage) | 101.979 |
| Sweet Apple & Molasses Flavor (PC-0555) | 2499.3 |
| Corn Starch, NF | 500.0 |
| Sucrose, NF | 3898.021 |
| Magnesium Stearate, NF | 100.0 |
| Soybean Oil, USP | 700.0 |
| Glycerin, USP | 1300.0 |
| Tenox 8 | 0.7 |
| Polyethylene Glycol, NF 3350 | 900.0 |
| Total Lot Weight: | 10000.0 g |

The process used for mixing the components was as follows:

1. All the components were weighed.

2. All the dry components, beginning with the Sweet Apple & Molasses Flavor, then the corn starch, then the sucrose, and then the magnesium stearate were mixed in a 20 quart Hobart mixer at speed 1 for about 1 minute, to produce a uniform blend.

3. The liquid components, beginning with the soybean oil, then the glycerin, and then the tenox 8 were mixed in a steel beaker with a spatula.

4. The polyethylene glycol was then heated to 60° C. in a stainless steel beaker to form a liquid.

5. The liquid from step 3 was then added to the Hobart mixer and mixed for 5 minutes to produce a wet granulation mix.

6. The melted PEG,from step 4 was then added to the Hobart mixer and mixed for 15 minutes to produce a wet granulation mix.

7. The wet granulation mix was then added to a Formax F6 machine to produce soft chews of the present invention.

Physical Characteristics of the Soft chew:

The soft chews formed from the above section had the following general characteristics:

| | | |
|---|---|---|
| Soft chew Weight: | 4838.7 | mg |
| Soft chew Hardness | 0.0 | Kp |
| Soft chew Thickness | 0.504 | inches |
| Soft chew Friability | 0.08% | |
| Time to Disintegrate | 14.45 | minutes |
| (6 soft chews, 37° C.) | | |

Palatability Study:

100.0% of the test horses consumed the control upon free choice. 95.0% of the test horses consumed the soft chew of the present invention upon free choice. 5.0% of the test horses consumed the soft chew of the present invention upon placing the soft chew in the horse's feed. Therefore, all of the test horses consumed the soft chew. The results of the study illustrate that an embodiment of a soft chew of the present invention, with additive, is palatable for a horse.

### Example 2

### Canine Soft Chew

Mixture of Components:

A batch of dough with active/additive ingredients was made with the following components: Each component is illustrated in grams/batch. There were no additive(s) added.

| Ingredients | gram/batch |
|---|---|
| Artificial Beef Flavor (PC-0125) | 810.0 |
| Sweet Apple & Molasses Flavor (PC-0555) | 594.0 |
| Corn Starch, NF | 79.567 |
| Fenbendazole Granulation | 1890.0 |
| Praziquantel | 59.051 |
| Aspartame, NF | 59.40 |
| Ivermectin Concentrate (5% overage) | 71.442 |
| Magnesium Stearate, NF | 54.0 |
| Soybean Oil, USP | 594.0 |
| Glycerin, USP | 702.0 |
| Tenox 8 | 0.54 |
| Polyethylene Glycol, NF 3350 | 486.0 |
| Total Lot Weight: | 5400.0 g |

The process used for mixing the components was as follows:

1. All the components were weighed.

2. All the dry components, beginning with the Sweet Apple & Molasses Flavor, the Artificial Beef Flavor, then the corn starch, the active ingrediemts, then the sucrose, and then the magnesium stearate were mixed in a 20 quart Hobart mixer at speed 1 for about 1 minute, to produce a uniform blend.

3. The liquid components, beginning with the soybean oil, then the glycerin, and then the tenox 8 were mixed in a steel beaker with a spatula.

4. The polyethylene glycol was then heated to 70° C. in a stainless steel beaker to form a liquid.

5. The liquid from step 3 was then added to the Hobart mixer and mixed for 5 minutes to produce a wet granulation mix.

6. The melted PEG from step 4 was then added to the Hobart mixer and mixed for 10 minutes to produce a wet granulation mix.

7. The wet granulation mix was then added to a Formax F6 machine to produce soft chews of the present invention.

Physical Characteristics of the Soft Chew:

The soft chews formed from the above section had the following general characteristics:

| | | |
|---|---|---|
| Soft chew Weight: | 5292.0 | mg |
| Soft chew Hardness | 0.0* | Kp |
| Soft chew Thickness | 0.588 | inches |
| Soft chew Friability | 0.18% | |
| Time to Disintegrate | >60.0 | minutes |
| (6 soft chews, 37° C.) | | |

*Soft Chew was to soft, no reading

Control Soft Chew:

A control soft chew was chosen for comparison of the palatability of this embodiment of the present invention. A product identified as the Interceptor 23 mg Flavor Tablet, prepared by Novartis Animal Health Co., was chosen as a control. The control was a direct compression product, 960 mg/tablet.

Palatability Study:

A palatability study was conducted as follows:

1. Twenty (20) canines were randomly selected. The breeds selected included Labradors, Shelties, Collies, Rottweilers, and other mixed breeds. The weight of the canines was between 20 pounds and 150 pounds. The age range was 1 year to 14 years, with a mean age of 4.6 years. The canines were evenly divided between males and bitches.

2. Each canine was presented with two product offers per day over a two day period. One product offer of a soft chew of the present invention and one product offer of the control, Interceptor product. This resulted in 40 tests.

3. Statistics were taken for % palatability (free choice), % palatable (with food), and % refused. The soft chews results indicated that 85.0% of the canines took the soft chew of the present invention (free choice), 7.5% of the canines took the soft chew of the present invention (with food), therefore, leaving only a 7.5% refusal. The control Interceptor product's results indicated that 75.8% of the canines took the soft chew of the present invention (free choice), 21.7% of the canines took the soft chew of the present invention (with food), therefore, leaving only a 2.5% refusal. As can be seen, the embodiment of the soft chew of the present invention performed better than the control, was accepted at a greater percentage through free choice.

What is claimed is:

1. A pharmaceutical soft chew formulation soft chew comprising a flavoring component of between about 0.1 to about 50 percent, a starch component of between about 5.0 to about 60 percent, a sugar component of between about 5.0 to about 75 percent, an oil component of between about 1.0 to about 40 percent, and a first additive comprising an active ingredient wherein the moisture content is about 5.0 percent to about 7.5 percent and wherein the soft chew is formed by knockout, wherein the soft chew is not an extrudate.

2. The soft chew of claim 1 further comprising a stabilizer component of between about 0.0 to about 3.0 percent.

3. The soft chew of claim 1 further comprising an emulsifier component of between about 0.0 to about 40 percent.

4. The soft chew of claim 1 further comprising a second additive selected from the group consisting of a pharmaceutical, a nutraceutical, a vitamin. and a mineral.

5. The soft chew of claim 4 further comprising a third additive selected from the group consisting of a pharmaceutical. a nutraceutical, a vitamin, and a mineral.

6. (canceled)

7. The soft chew of claim 1 wherein the flavoring component is selected from the group consisting of fruit, meat, vegetable, cheese, cheese-bacon and/or artificial flavorings.

8. The soft chew of claim 6 wherein any of the first additive, the second additive, and the third additive is a pharmaceutical and the pharmaceutical is selected from the group consisting of ivermectin, fenbendazole, piperazine, magnesium hydroxide, stranozole, furosemide, penicillin, amoxicillin, prednisolone, methylprednisolone, acepromazine, aspirin, PROZAC, ZANTACS, BENADRYL, praziquantel, pyrantel, HOE 120739, Sumitomo Chemicals-1638, Nitenpyram, spinosad and omeyprazole.

9. A process for introducing at least one additive to an organism comprising offering the soft chew of claim 1 or claim 8 to the organism, whereby, upon consumption, the additive is ingested by the organism.

10. The process of claim 9 wherein the organism is selected from the group consisting of a horse, cow, pig, goat, sheep, llama, deer, duck, chicken, dog, cat, lion, tiger, bear, an ox, buffalo, fish, human and the like.

11. A process for making a soft chew comprising the steps of:
a. mixing a flavoring component, a starch component, a sugar component, an oil component, and an additive into a dough;
b. heating the dough; and,
c. forming the soft chew with a knockout, such that the soft chew is not an extrudate.

12. The process of claim 11 wherein the step of heating the components comprises heating the oil component prior to mixing.

13. The process of claim 11 wherein the step of forming the soft chew comprises moving the dough from a hopper to a press.

14. A process for delivering an additive to an organism comprising administering a soft chew according to claims 1 to an organism.

15. A process of forming a soft chew comprising the steps of:
a. mixing a flavoring component, a starch component, a sugar component, an oil component, and an additive into a dough;
b. heating the dough; and,
c. knocking out a soft chew.

16. The process of claim 15 wherein the step of knocking out is performed on a patty pressing machine.

17. The process of claim 15 wherein the soft chew further comprises additional additives.
